(19) United States
(12) Patent Application Publication
(10) Pub. No.: US 2005/0189402 A1
(43) Pub. Date: Sep. 1, 2005

(54) Area array and leaded SMT component stenciling apparatus and area array reballing method

(75) Inventors: William Westmoreland, Arlington Heights, IL (US); Raymond Cirimele, Schaumburg, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Bandjwet Enterprises, Rolling Meadows, IL (US)

(21) Appl. No.: 11/057,325

(22) Filed: Feb. 11, 2005

Related U.S. Application Data
(60) Provisional application No. 60/543,708, filed on Feb. 11, 2004.

(51) Int. Cl. B23K 1/00

(52) U.S. Cl. 228/215; 228/214; 228/33

(57) ABSTRACT

The present invention relates to a method of applying solder paste, flux or adhesive to a component site on a printed circuit board in order to mount an electronic component on the printed circuit board. The method includes the steps of aligning a flexible stencil with the component site on the printed circuit board such that apertures in the stencil are aligned with desired contact locations at the component site and adhering the stencil to the printed circuit board using a permanent adhesive. Solder paste, flux or adhesive is applied onto the stencil such that the solder paste, flux or adhesive fills a plurality of the apertures in the stencil the electronic component is placed on the printed circuit board over the stencil. A method of applying new solder balls to a connection side of an electronic component is also provided. The new solder ball application method includes the steps of aligning a flexible stencil with the connection side of the electronic component such that apertures in the stencil are aligned with desired solder ball locations on the connection side of the electronic component and adhering the stencil to connection side of the electronic component using a permanent adhesive. Flux or solder paste is applied onto the stencil such that the flux or solder paste fills a plurality of the apertures in the stencil. The new solder balls are placed into the stencil apertures having flux or solder paste and the electronic component is heated in order to reflow the new solder balls. A stencil for performing these methods is also provided.

### CROSS-REFERENCE TO RELATED PATENT APPLICATIONS

This patent application claims the benefit of U.S. Provisional Patent Application No. 60/544,708, filed Feb. 11, 2004.

### FIELD OF THE INVENTION

The present invention relates to printed circuit board (PCB) reworking and repair, and in particular, to an apparatus and method for area array and leaded surface mount technology (SMT) component stenciling and area array reballing.

### BACKGROUND OF THE INVENTION

With the advent of surface mount technology, a new method of solder attachment between the components and the PCB was developed. In older, larger component packages, the through-hole leads and surface mount leads were directly soldered to or through the PCB. With such older device packages, all of the leads could be readily seen. For newer, higher-density area array packages, the direct soldering approach had to be updated to accommodate the greater number of inputs and outputs. These newer area array packages have contact points or balls on the bottom side of the package thereby increasing interconnection density. However, these contact points are not physically accessible or visible after the device has been soldered to the PCB.

During the original assembly of surface mount PCBs, solder paste is stenciled onto the mounting pads where the components will be later placed utilizing a stencil printing method. In particular, a metal stencil with openings corresponding to the pad patterns on the PCB is used to create the desired pattern of solder paste. Stencil printing machines align the frame-mounted stencils to the empty, planar PCB and bring the two into intimate contact. A precision squeegee then drives the solder paste material through the apertures onto the surface of the mounting pads on the PCB in one pass. All of the component connection locations on the entire PCB surface are printed in one automated operation. Subsequently, the components are placed onto the PCB with their contact interconnects aligning to these solder paste patterns. The solder paste is then melted in an oven reflow operation, thereby making the connections between the components and the PCB.

Semiconductor components often must be reworked and replaced. For example, rework and replacement can be required when there is a change in a part revision level, a product upgrade or the PCB and/or semiconductor component needs to be repaired. Rework of area array components such as ball grid arrays, chip scale packages and other surface mount packages first requires removal of the device from the circuit board. New solder paste or flux must be reapplied to the circuit board before a replacement component is reattached. During rework, the primary stencil used during the original manufacturing of the PCB can no longer be used because of the various components that are arranged on the PCB. Accordingly, another method must be used to re-apply both solder paste and flux to the new, replacement component on the populated PCB.

One of the most common methods for the re-application of solder paste is a miniaturized metal stencil. This miniature stencil is used in a similar manner to the original primary stencil. Specifically, a flat miniature metal stencil is manually aligned with the rework space and the metal edges are taped off to the PCB to secure the stencil in place. Alternatively, this miniature metal stencil can be aligned with a mechanical arm. However, using a mechanical arm requires a separate setup operation for each component location. With both the manual and mechanical alignment methods, the hold down force of the stencil to the PCB can be insufficient or uneven. Accordingly, the miniature stencil can shift during the squeegee operation requiring the stencil to be removed and cleaned and the stenciling operation repeated. Also, each of the stencils must be thoroughly cleaned prior to re-use, which is a time-consuming operation. Another problem with these metal stencils is that they lack the rigidity and mechanical support of the original stencil frame, which makes it more difficult to achieve the same results obtained during the primary surface mount printing process.

There are several more problems associated with such metal stencils. For example, there can be situations where the metal stencil, being a custom-designed metal pattern, cannot easily fit in between components on the PCB. In addition, due to improper sealing or gasketing of the mini stencil to the PCB substrate, “bleeding” of the solder paste outside of the desired stencil area may occur. Because of these difficulties, a user of these miniature metal stencils must have a high degree of skill to deposit the proper amount of solder paste with a single squeegee pass.

A less common method for solder paste re-application is the use of a syringe to place solder at each contact pad. This can be a time-consuming process. In addition, the amount of solder dispensed on the contact pad of a component is inconsistent and difficult to control precisely given the small geometries of today's fine-pitched components.

A disposable, flexible stencil made for example of laminated paper is another method used to reapply solder paste. The disposable stencil is placed in position by forming and shaping the stencil into the available space. An adhesive backing is provided on the disposable stencil for adhering the stencil in position on the PCB. Solder paste is then dispensed onto the stencil surface and distributed across the stencil surface using a squeegee until all the apertures in the stencil are filled. The disposable stencil is then peeled away from the PCB surface revealing the solder paste pattern. When the disposable stencil is peeled away, some of the solder paste can be stuck in the apertures of the stencil and the solder paste can be smeared across the land patterns. Moreover, after many re-uses, the adhesive on the disposable stencil will wear off further degrading the effectiveness of the disposable stencil and leading to solder paste smears to adjacent pads or sites. After the stencil is used a certain number of times, it is discarded.

A hand soldering operation is the most common method used to re-attach leaded surface mount devices. After such a leaded device is removed from a PCB, any remnant solder is first wicked off the site on the PCB. The site is then cleaned and dried. A replacement device can then be placed into position. The placement of the new device requires careful alignment. Once in position, two corners of the new device are tacked down in order to hold the device in alignment for soldering. Because the current lead and pad dimensions of leaded devices are shrinking ever smaller, this alignment process requires a great deal of skill and patience. Moreover, the subsequent soldering of the leads also requires a skilled technician. However, even if great care is exercised, solder bridges between leads, improper wetting or too much or too little solder volume on each joint can occur.

During the rework process, the components such as grid array packages that are removed from the PCB are occasionally salvaged and reused. To reuse grid array packages, solder balls generally have to be reapplied to the removed grid array packages. One relatively simple ball grid array reballing method involves the use of ball grid array preforms. These preforms consist of an array of solder spheres embedded in a water-soluble carrier. First, flux is applied to the pad side of the grid array package. Using a soldering iron and de-soldering braid the “old” balls can be removed from the pads of the package. The package is then cleaned with isopropyl alcohol and rinsed and brushed with deionized water. After fluxing the grid array, the component and preforms are manually aligned relative to each other using a small fixture and the preform is secured to the component. In the case of components having smaller input/output counts or larger pads and spheres, this alignment can be done visually. The component with the adhered preform is then placed in a reflow oven. Upon removal from the reflow oven, the carrier is allowed to cool and moistened with water. A backing material on the preform is then peeled away leaving the solder balls on the pads of the component.

There are several challenges associated with using these preforms. One of these is keeping the fixtures used in the alignment process clean and properly adjusted because the fixtures are made from light gauge metal and are easily bent or shifted out of position. Any bows or bends in the fixture can make placement of the preform on the component difficult. Another shortcoming of the preform method is that it can be difficult to provide the proper reflow profile necessary to insure consistent compression of the solder balls and thereby prevent shorts between pads. Lastly, removing the fragments of backing material of the preforms, especially for larger arrays, can be very tedious and time-consuming and could result in solder mask insulation being scratched off the PCB.

### BRIEF SUMMARY OF THE INVENTION

The present invention relates to the reworking and re-assembly of electronic components onto a PCB and reballing of ball grid array components. More specifically this invention is an improved stenciling apparatus and method of both solder paste/flux/adhesive deposition, component alignment or solder ball placement. The methodology is specifically designed for the rework and reballing of area array components such as chip scale packages, ball grid arrays, leaded or leadless surface mount packages.

In the case of reballing an area array component, a thin stencil is pressed onto the component. The holes are filled with flux. Following this operation, the holes of the stencil are then filled with solder balls. After this process, the part is reflowed to finish the attachment onto the electronic assembly or the solder balls are reflowed onto the electrical interconnects on the array device.

### BRIEF DESCRIPTION OF THE DRAWINGS

FIG. 1 is a top plan view of an illustrative stencil in accordance with the present invention.

FIG. 2 is a diagrammatic depiction of the placement of the stencil of FIG. 1 on a PCB during a PCB rework or repair process.

FIG. 3 is a diagrammatic depiction showing the application of solder paste to the stencil of FIG. 1 during the PCB rework or repair process.

FIG. 4 is a diagrammatic depiction showing the stencil after the solder paste has been applied.

FIG. 5 is a diagrammatic depiction showing the placement of an electronic component over the stencil on the PCB.

FIG. 6 is a diagrammatic depiction of an alternative embodiment of the present invention in which the stencil is arranged over the pads of an area array device for a reballing process.

FIG. 7 is a diagrammatic depiction showing the dispersal of the new solder balls onto the stencil during the reballing process.

FIG. 8 is a diagrammatic depiction showing the stencil after all of the new solder balls are in place in the stencil apertures after the reflow step is completed during the reballing process.

### DETAILED DESCRIPTION OF THE INVENTION

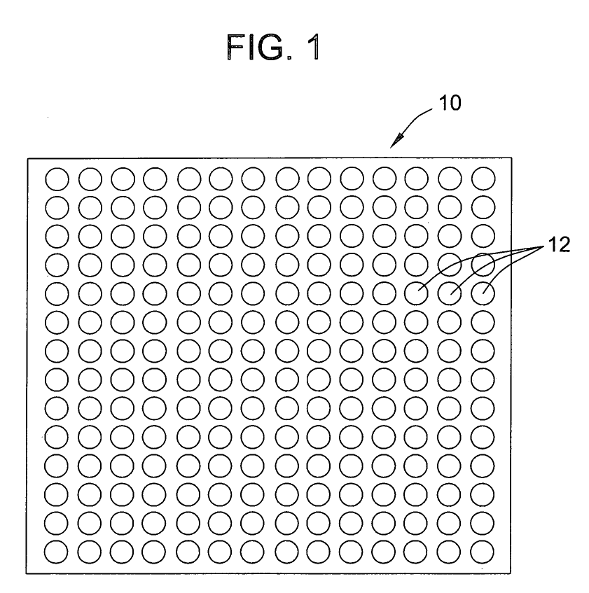

Referring now more particularly to FIG. 1 of the drawings there is shown an exemplary stencil 10 constructed in accordance with the present invention. The illustrated stencil is a single use stencil that can be used to apply flux, solder paste or adhesive to a PCB and is particularly useful in the context of reworking or repairing of electronic components such as ball grid arrays and chip scale packages as well as other area array components mounted on the surface of a PCB. In rework or repair operations, a component is removed from an already populated PCB and replaced with a different or repaired component. The stencil 10 is also useful in reballing operations in which new solder balls are added to an electronic component such as an area array component before it is mounted on the PCB.

The stencil 10 generally comprises a flexible material having a plurality of apertures 12 formed therein, in this case, in a grid array pattern. In particular, the apertures 12 in the stencil 10 are in a predetermined pattern that corresponds to the interconnect pattern on the PCB site or area array component with which the stencil is to be used. For example in a PCB rework operation, the apertures 12 could be arranged to correspond to the land pattern on the site on the PCB where the component is to be replaced. In addition, the shape of the stencil 10 can be configured to correspond to the shape of the component to be added. As will be appreciated, the stencil 10 can have a variety of different configurations and aperture patterns depending on what is necessary for a particular reworking or repair operation and the present invention is not limited to any particular stencil configuration or aperture pattern. As an alternative to having a stencil that is manufactured to directly match the desired site land pattern and component configuration, a user could manually trim the stencil 10 at the time of usage to fit a particular pad pattern and component. The thickness of the stencil 10 can also vary depending upon the application in which it is to be used. For a PCB rework operation, the stencil 10 generally should be of sufficient thickness to ensure proper solder volume is present at the interconnection.

Similarly, in the context of use in a reballing operation, the apertures 12 should be arranged to correspond to the pad locations on the area array component that is to be reballed. Additionally, the shape of the stencil 10 should correspond to the shape of the area array component being reballed or alternatively be designed so that it can be manually trimmed to fit on the area array component. For reballing operations, the stencil 10 should be of sufficient thickness to hold the new solder balls in place.

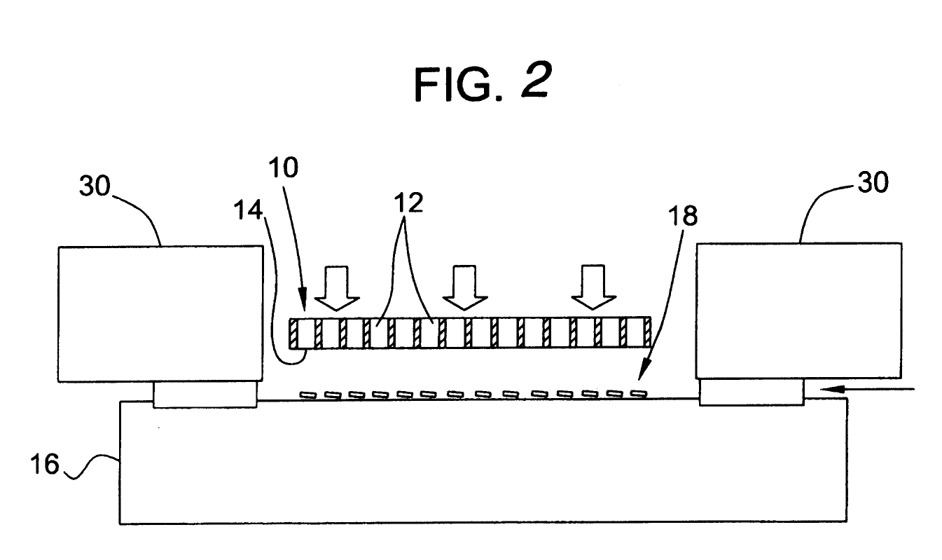

To allow the stencil to be secured to a PCB, the bottom or under side 14 of the stencil 10 is coated with an adhesive (see FIG. 2). The adhesive is preferably a high temperature, permanent or semi-permanent adhesive that will ensure that the stencil 10 will stay adhered to the PCB or area array component for a prolonged period of time even at elevated temperatures. To ease handling of the stencil 10, a release liner such as a paper backing can cover the adhesive. This release liner is then removed just prior to securing the stencil in place on the PCB. The stencil 10 can be made of any suitable flexible material. In a preferred embodiment of the invention, the stencil 10 is constructed of a flexible polymer material. One example of a suitable material for the stencil is polyimide sold by DuPont under the tradename Kapton®. Optionally, the stencil could be amber in color similar to the colors commonly used in PCB manufacture and be translucent.

Referring to FIGS. 2-5, when used in PCB rework operation, if necessary, the stencil 10 is first trimmed to fit on the particular site on the PCB 16. The release liner is then removed from the stencil 10 exposing the adhesive. The stencil 10 is then aligned with the pattern of lands 18 on the PCB 16 and pressed into place (see FIG. 2) between the existing PCB components 30. Advantageously, the stencil 10 can be handled and aligned manually. The adhesive is formulated such that the user can re-apply and re-align the stencil several times until it is placed correctly over the land patterns. Moreover, the stencil 10 can be easily trimmed to fit into very tight areas that would normally prevent paste application using a metal stencil. The flexible material of the stencil 10 and the adhesive also help the stencil conform to the contours of the rework area including any surface irregularities.

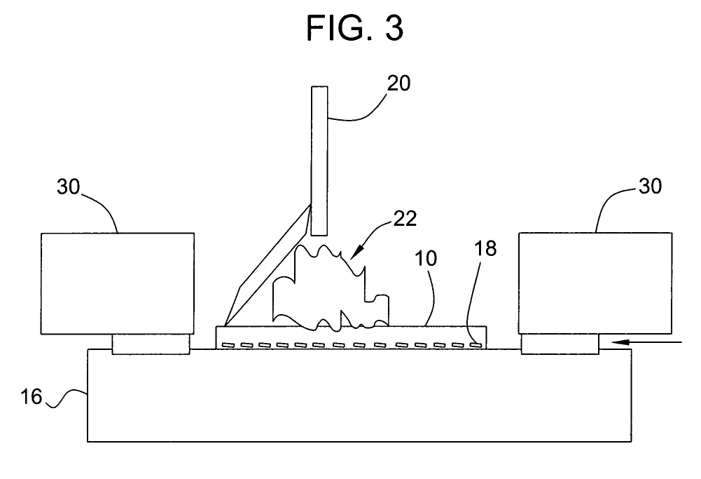

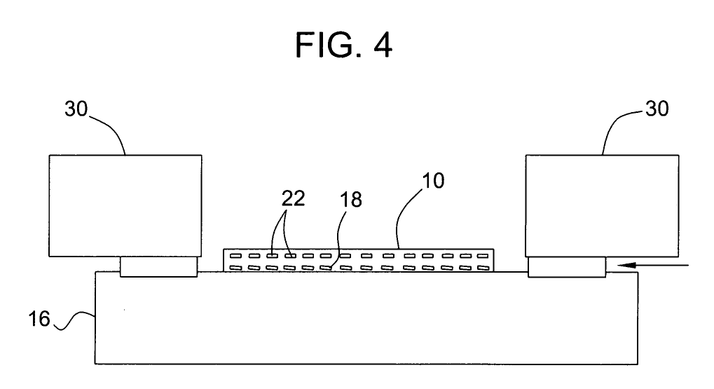

After the stencil 10 is adhered in the proper position on the PCB 16, a squeegee 20 is then used to roll a bead of solder paste 22 across and down through the apertures 12 of the stencil 10 as shown in FIG. 3. The solder paste 22 should be applied until each aperture 12 in the stencil 10 is filled to a point approximately level with the upper surface of the stencil (see FIG. 4). Alternatively flux may be applied. Because it is flexible and secured with an adhesive, the stencil 10 of the present invention achieves a very tight seal or “gasketing” with the surface of the PCB. The stencil also provides insulation between land patterns, which eliminates the need to repair previously-damaged soldermask. This tight seal allows multiple passes of the squeegee to be used without any solder paste being squeezed under the stencil. The adhesive also helps reduce the possibility that the stencil will shift during the solder paste application process. Moreover, because the stencil 10 remains in place after the solder paste is applied, the potential for smearing of the solder paste deposit or paste release problems upon removal of the stencil is eliminated. Instead, the stencil 10 holds the solder paste in the proper position even when the solder is reflowed in an oven.

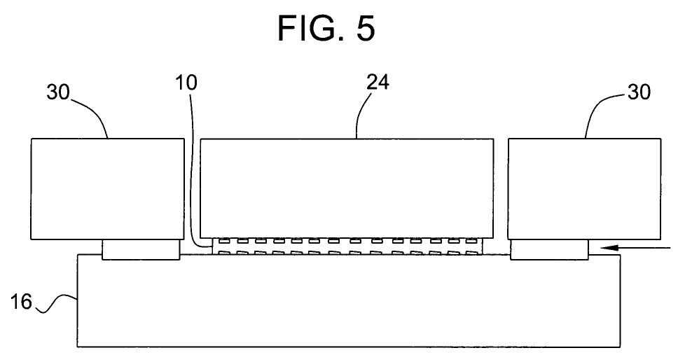

Once the solder application is completed, the replacement component 24 is placed on the circuit board as shown in FIG. 5. Advantageously, the stencil 10 stays in place on the PCB 16 and becomes a permanent part of the assembly. Moreover, during placement of the replacement component 24, the stencil 10 can be used as an alignment tool. In particular, the technician placing the replacement component 24 can feel the balls or leads on the component settle into the apertures 12 in the stencil 10 when the component is in the proper position. The ability to manually align the component eliminates the need for costly vision systems to assist in the placement of the replacement component.

After the new component 24 is placed on the PCB 16, the entire PCB assembly including the solder paste 22, stencil 10 and new component are heated in order to reflow the solder and thereby connect the interconnects on the PCB to the interconnects on the replacement component. The heating can be accomplished using any suitable heat source and is carried out at the temperature and for the time necessary to reflow the solder paste. Because the stencil 10 is made of an insulating material and is designed to remain in place on the PCB 16 it provides a permanent insulating barrier between the solder pads connecting the PCB and the replacement component thereby preventing shorts between adjacent solder pads. The stencil 10 also acts as a spacer between the interconnects on the PCB 16 and the replacement component 24 which helps to prevent any tilt in the component after the rework is completed.

Advantageously, the stencil and associated PCB rework method of the present invention opens up the processing window for reworking grid array parts thereby simplifying the rework process. Specifically, in many cases the present invention allows the rework procedure to be simplified through the use of less capital-intensive tools such as heat guns. In addition, the present invention simplifies the rework process to the extent that smaller business entities can undertake such reworking on their own. The present invention also eliminates or reduces the costs associated with fixtures used in the rework process.

In the context of leaded surface mount components, the present invention eliminates the need for highly skilled solder technicians. Moreover, a further advantage of the invention is that it speeds up the rework process of leaded surface mount components while achieving higher quality work. For example, after the old leaded component is removed from the PCB, the wicking of the solder pads is not required. Any unwicked solder left over from the old component removal operation becomes an area where the solder paste does not need to be deposited onto the printed circuit board. The spacing between leads defined by the stencil helps insure that solder does not “bridge” between leads thereby causing shorts. In addition, the placement of the leads inside of the stencil apertures insures proper device alignment onto the PCB pads.

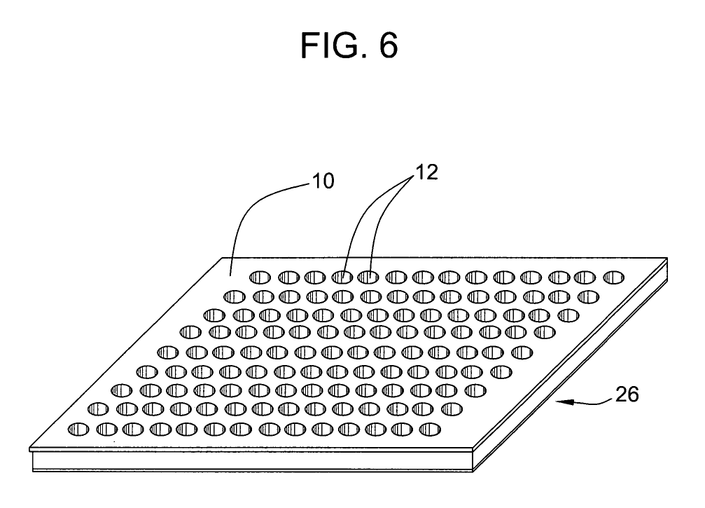

As noted above and with reference to FIGS. 6-8, the stencil 10 of the present invention can also be employed in a process for applying new solder balls 28 onto the underside of a grid array component 26 for rework. This process is sometimes referred to as reballing. In the reballing process, flux is first applied to the underside of the grid array component 26. A soldering iron along with solder braid can then be used to remove the old solder balls from the pads of the grid array component 26. After the old solder balls are removed, the component 26 is cleaned such as through the use of isopropyl alcohol and a brush or another suitable solvent followed by a rinse with deionized water. The grid array component 26 is then ready for application of the stencil of the present invention.

During the reballing process, the flexibility of the stencil is not critical, therefore the stencils used for reballing can be made from the adhesive backed polyimide material or any other materials that are heat resistant, capable of being laser drilled, and cannot be wetted by molten solder.

There are two predominant methods for the reballing of the grid array component 26. One method attaches the new solder balls 28 through the use of flux only. This is a very common method for solder ball 28 attach. The other method utilizes a solder paste attachment for the new solder balls 28.

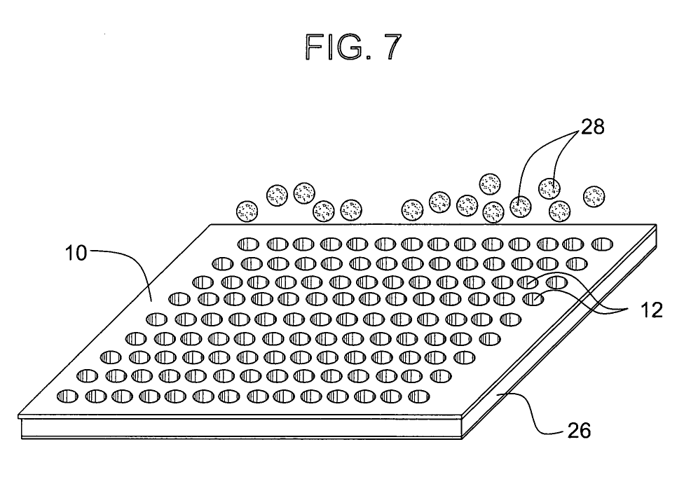

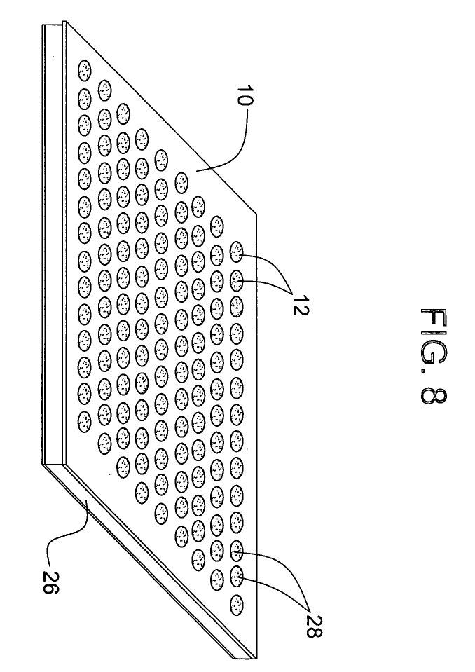

When performing the reballing process utilizing the flux only method, only a single stencil is needed. After removal of the release liner, the stencil is aligned to the pads of the grid array component 26 with the adhesive side down towards the grid array component 26 and then pressure is applied to secure the alignment. Flux is applied and evenly spread over the stencil apertures 12. The proper diameter solder balls 28 are then poured into the apertures 12 in the stencil 10 with the apertures holding the new solder balls in position (see FIGS. 7-8). Optionally, a second stencil can be placed over the initial stencil after the flux is applied to receive the new solder balls. The grid array component 26 is then heated to the temperature and for the time necessary to reflow the solder balls 28. This heating can be accomplished with any suitable heat source. When the component is removed from the reflow oven, the new balls are securely connected to the grid array component. At this point, the stencil may be left in place or peeled off the grid array component.

When performing the reballing process utilizing the solder paste attachment method, it is necessary to use two stencils, one for the paste print, and one for the solder ball alignment. After removal of the release liner, the stencil is aligned to the pads of the grid array component 26 with the adhesive side down towards the grid array component 26 and then pressure is applied to secure the alignment. A squeegee is then used to fill the apertures of the stencil with the solder paste. The grid array component is then heated to the temperature and for the time necessary to reflow the solder paste. The stencil can now be peeled off the grid array component and the component can be cleaned. A new stencil is then applied to the grid array component and the proper diameter solder balls 28 are then poured into the apertures 12 in the stencil 10 with the apertures holding the new solder balls in position (see FIGS. 7-8). Optionally, a second stencil can be placed over the initial stencil after the flux is applied to receive the new solder balls. The grid array component 26 is then heated to the temperature and for the time necessary to reflow the solder balls 28. This heating can be accomplished with any suitable heat source. When the component is removed from the reflow oven, the new balls are securely connected to the grid array component. At this point in time the stencil may be left in place or peeled off the grid array component.

The use of the stencil 10 in a reballing process offers several advantages. First, the stencil 10 is easily aligned to the pads on the grid array component. The adhesive backing also keeps the stencil fixed in position. Since the stencil 10 is made of an insulating material, the stencil ensures proper insulation between adjacent solder pads. The use of the stencil also simplifies the reballing process and reduces the costs associated with the process. For example, the time associated with dissolving the water-soluble carrier used in existing preforms and scraping off the remnant paper pieces of the carrier is eliminated. The stencil also eliminates the need for metal fixtures. This simplification of the process and reduction in cost could allow some companies to eliminate outsourcing of the reballing process.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context

1. A method of applying solder paste, flux or adhesive to a component site on a printed circuit board in order to mount an electronic component on the printed circuit board, the method comprising the steps of:
aligning a flexible stencil with the component site on the printed circuit board such that apertures in the stencil are aligned with desired contact locations at the component site;
adhering the stencil to the printed circuit board using a permanent adhesive;
applying the solder paste, flux or adhesive onto the stencil such that the solder paste, flux or adhesive fills a plurality of the apertures in the stencil; and
placing the electronic component on the printed circuit board over the stencil.

2. The method of claim 1 further including the step of trimming portions of the stencil to correspond to a shape of the component site.

3. The method of claim 1 wherein the stencil is made of polyimide material.

4. The method of claim 1 wherein the stencil is made of an electrically insulative material.

5. The method of claim 4 wherein the apertures in the stencil are spaced from each other so as to provide a desired dielectric barrier between adjacent contact locations.

6. The method of claim 1 further including the step of taping off portions of the stencil to correspond to a shape of the component site.

7. A method of applying new solder balls to a connection side of an electronic component, the method comprising the steps of:
aligning a flexible stencil with the connection side of the electronic component such that apertures in the stencil are aligned with desired solder ball locations on the connection side of the electronic component;
adhering the stencil to connection side of the electronic component using a permanent adhesive;
applying flux or solder paste onto the stencil such that the flux or solder paste fills a plurality of the apertures in the stencil;
placing the new solder balls into the stencil apertures having flux or solder paste; and
heating the electronic component in order to reflow the new solder balls.

8. The method of claim 7 further including the step of trimming the stencil to correspond to a shape of the electronic component.

9. The method of claim 7 wherein the stencil is made of polyimide material.

10. The method of claim 7 wherein the stencil is made of an electrically insulative material.

11. The method of claim 10 wherein the apertures in the stencil are spaced from each other so as to provide a desired dielectric barrier between adjacent contact locations.

12. The method of claim 7 further including the step of removing the stencil from the electronic component after the component is heated to reflow the new solder balls.

13. The method of claim 7 wherein the stencil is left on the electronic component after the component is heated to reflow the new solder balls.

14. The method of claim 7 wherein the stencil is a first stencil and further including the step of adhering a second stencil over the first stencil after applying the flux or solder paste and before placing the new solder balls in the apertures such that the apertures in the first stencil are aligned with apertures in the second stencil.

15. A stencil for applying solder paste, solder balls, flux or adhesive to a component site on a printed circuit board, the stencil comprising a flexible, electrically insulative material having a plurality of apertures formed therein in a predetermined pattern, the stencil material having a first side on which an adhesive is carried, the adhesive being capable of permanently affixing the stencil to the printed circuit board, and a removable release liner arranged over the adhesive on the first side of the stencil material.

16. The stencil of claim 15 wherein the stencil is made of polyimide material.

17. The stencil of claim 15 wherein the apertures in the stencil are spaced from each other so as to provide a desired dielectric barrier.
